(19) United States
(12) Patent Application Publication
(10) Pub. No.: US 2014/0028477 A1
(43) Pub. Date: Jan. 30, 2014

(54) VEHICLE LOCATION SYSTEM

(71) Applicant: Steven C. Michalske, Sunnyvale, CA (US)

(72) Inventor: Steven C. Michalske, Sunnyvale, CA (US)

(73) Assignee: APPLE INC., Cupertino, CA (US)

(21) Appl. No.: 13/556,985

(22) Filed: Jul. 24, 2012

(51) Int. Cl. G08G 1/123

(52) U.S. Cl. 340/990; 340/989

(57) ABSTRACT

Techniques are provided for locating a parked vehicle using a mobile device. In one embodiment, the mobile device may automatically detect when a moving vehicle is being parked and save its GPS location at that point at the location of the parked vehicle. The mobile device may later output the saved location of the parked vehicle when a user, such as the driver of the parked vehicle, requests the information. In some embodiments, the mobile device may communicate with the vehicle in order to determine when the vehicle is being parked.

### BACKGROUND

The present disclosure relates generally to a vehicle location system, and more particularly to saving and retrieving the location of a parked vehicle on a mobile device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Handheld electronic devices, such as mobile phones and tablet devices, have become increasingly prevalent in today's society. In addition to placing phone calls, the electronic devices may be used to perform many functions, such as storing contact information, accessing email, accessing the internet, acting as a global positioning system (GPS) map, and so forth. Due to their multi-functionality, many users use their handheld electronic devices for many aspects of their day to day lives, including for navigational purposes while driving or travelling. As such, users may generally keep their handheld electronic devices with them during many daily activities, including driving from one place to another. Thus, users may bring their handheld electronic devices when they get into their car and take it with them when they exit the vehicle.

For a large portion of the population, driving a personal vehicle is the preferred mode of transportation. Generally, when drivers arrive at a location, the driver may park their vehicle in a parking lot, parking garage, street, or other designated or undesignated locations. Oftentimes, for many reasons, drivers may have trouble remembering or finding where they parked their vehicle. For example, a parking lot may be very large, with many similar looking lanes and sections, and filled with many vehicles. In such a situation, drivers may have trouble locating their vehicles.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems and methods for locating a parked vehicle. Specifically, a mobile device such as a cellular telephone may automatically save the location of location when it is parked and later retrieve that location and output it to a user. The present techniques allow the mobile device to automatically detect when the vehicle is parked and save the parking location.

In some embodiments, the mobile device may first detect that it has been brought inside the vehicle, which may indicate that the user intends to drive the vehicle somewhere. The mobile device may detect being inside the vehicle by establishing a Bluetooth connection with a Bluetooth device which is coupled to the vehicle. Later, when the user parks and exits the vehicle, the mobile device may lose the Bluetooth connection with the vehicle's Bluetooth device. This indicates to the mobile device that the vehicle has been parked, and the mobile device saves its location of when the Bluetooth connection is lost. This location may generally be similar to the location where the vehicle was parked. Thus, the saved location may generally be the location of the parked vehicle.

In some embodiments, the Bluetooth connection may be replaced with a USB cable or car charger, which also couples the mobile device to the vehicle. As a user may plug the mobile device into the USB cable or car charger when entering the vehicle, and unplug the mobile device from the USB cable or car charger when exiting, being unplugged from the USB cable or car charger may signal the mobile device to save the GPS location as the location of the parked vehicle.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with an embodiment;

FIG. 2 is a front view of an embodiment of the electronic device of FIG. 1 in the form of a mobile device, in accordance with an embodiment;

FIG. 3 is an illustration of a vehicle location system comprising a vehicle and a mobile device;

FIG. 4 is a flow chart of a process for saving and retrieving a vehicle location, in accordance with an embodiment;

FIG. 5 is an illustration of a vehicle having a Bluetooth device communicating with a mobile device, in accordance with an embodiment;

FIG. 6 is a flow chart of a process for saving and retrieving a vehicle location using the Bluetooth device of FIG. 5, in accordance with an embodiment;

FIG. 7 is an illustration of a vehicle mobile device charging system, in accordance with an embodiment;

FIG. 8 is a flow chart of a process for saving and retrieving a vehicle location using the vehicle mobile device charging system of FIG. 7;

FIG. 9 is an illustration of a mobile device being coupled to a moving vehicle via a Bluetooth or USB connection, in accordance with an embodiment; and

FIG. 10 is a flow chart for saving and retrieving a vehicle location based on motion detected by an accelerometer in the mobile device of FIG. 9.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to saving and retrieving vehicle locations on a mobile device. For example, a system, method, or combination thereof may automatically save and retrieve the location of a parked vehicle via a mobile device. The mobile device may be configured to automatically save the location of a vehicle when the vehicle is parked, and later output the location to a user and/or direct the user to the location of the parked vehicle.

When a user gets into a vehicle and drives to a new location, the user may also bring the user's mobile device along. As such, the mobile device generally enters the vehicle when the user enters the vehicle and exits the vehicle when the user exits the vehicle. In certain embodiments, when the mobile device enters the vehicle, it may be configured to communicate with the vehicle via a communication protocol or device. As such, the mobile device is able to detect that it is indeed inside the vehicle, which may initiate a vehicle locator system. The mobile device may also be configured to detect when the vehicle has been parked and automatically save the GPS location of the mobile device when the detection was made. Thus, the saved GPS location of the device may also be a GPS location of the vehicle when it was parked (e.g., the vehicle parking location). Later, when the user is trying to locate the parked vehicle, the mobile device m ay receive prompt or request from the user to show then where the vehicle is parked, a which point the mobile device may output the vehicle parking location and/or directions to the vehicle parking location relative to the user. The disclosure will describe various embodiments of such systems and methods for saving and retrieving the location of a parked vehicle.

In certain embodiments, the mobile device may be configured to automatically communicate with the vehicle such that the mobile device may detect when the vehicle is parked, and save the GPS location of the mobile device at that point as the location of the parked vehicle. It should be noted that the mobile device may generally be placed inside the vehicle while the vehicle is being driven, and that the GPS location of the mobile device when the vehicle is parked is generally also the location of the vehicle when it is parked. The mobile device may communicate with the vehicle via Bluetooth, a USB connection, and the like.

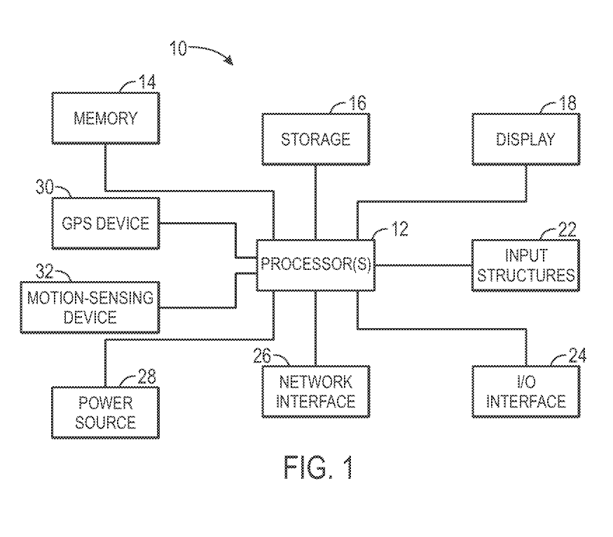

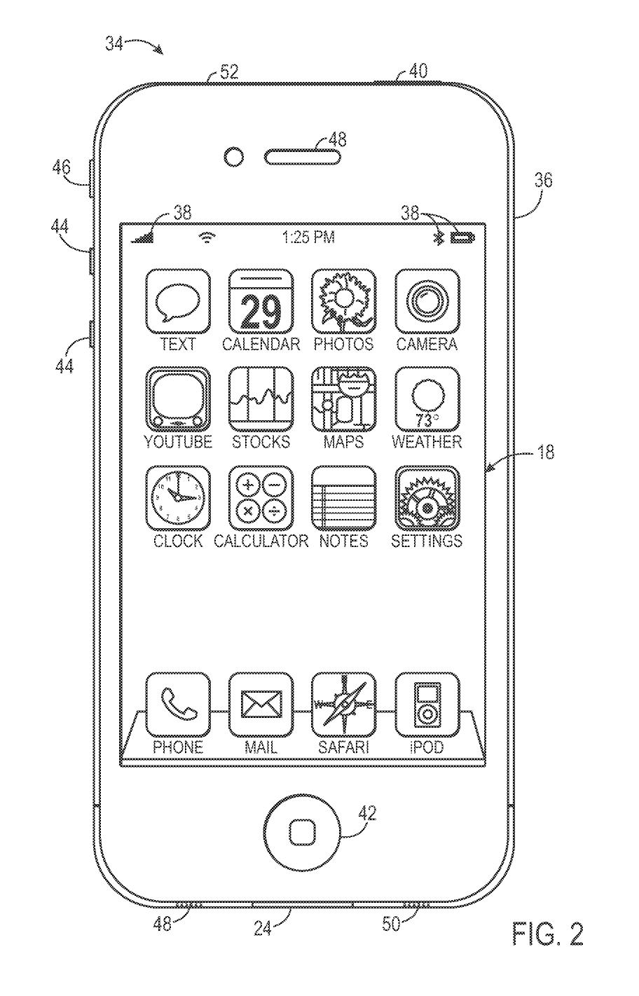

With the foregoing in mind, a general description of suitable mobile devices capable of saving and retrieving the location of a parked vehicle is described below. In particular, FIG. 1 is a block diagram depicting various components that may be present in a suitable mobile device. FIG. 2 illustrates a front view of a suitable mobile device, which may be, as illustrated, a handheld device such as a cellular telephone or Smartphone.

Turning first to FIG. 1, a mobile device 10 according to an embodiment of the present disclosure may include, among other things, one or more processor(s) 12, memory 14, non-volatile storage 16, a display 18, input structures 22, an input/output (I/O) interface 24, network interfaces 26, a power source 28, a global positioning system (GPS) device 30, and a motion-sensing device 32. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in the mobile device 10.

The processor(s) 12 may provide data processing capability to execute the operating system, programs, user and application interfaces, and any other functions of the mobile device 10.

The memory 14 may be provided as a volatile memory, such as random access memory (RAM), and/or as a non-volatile memory, such as read-only memory (ROM). The memory 14 may store a variety of information and may be used for various purposes. For example, the memory 14 may store firmware executed by the processor 12, such as basic input/output instructions or operating system instructions, including instructions for saving and retrieving a location, as discussed herein. In addition, the memory 14 may be used for buffering or caching during operation of the mobile device 10.

The non-volatile storage 16 may include flash memory, a hard drive, or any other optical, magnetic, and/or solid-state storage media. The non-volatile storage 16 may be used to store data files such as location information, software, wired and wireless connection information (e.g., information that may enable the mobile device 10 to establish a wired or wireless connection, such as a USB, Bluetooth or wireless network connection), and any other suitable data. Specifically, the non-volatile storage 16 and/or the memory 14 may store code and/or data for carrying out the disclosed techniques among others.

The display 18 may be a touch-screen liquid crystal display (LCD), for example, which may enable users to interact with a user interface of the mobile device 10. In some embodiments, the display 18 may be a MultiTouch™ display that can detect multiple touches at once. The input structures 22 of the mobile device 10 may enable a user to interact with the mobile device 10 (e.g., pressing a button to increase or decrease a volume level). For example, the input structures 22 may include buttons, sliders, switches, control pads, keys, knobs, scroll wheels, keyboards, mice, touchpads, and so forth. The input structures 22 also allow the user to input certain commands, prompts, or requests into the device. Responses to the user inputs may be displayed on the display 18, output as sound, or simply saved in the mobile device 10.

The I/O interface 24 may enable mobile device 10 to interface with various other electronic devices such as computers, other mobile devices, power sources, and so forth. The I/O interfaces 24 may support any standard or proprietary interface type, such as a universal serial bus (USB) port, a video port, a serial connection port, an IEEE-1394 port, an Ethernet or modem port, an AC/DC power connection port, and so forth.

In certain embodiments, the I/O 24 interface may be coupled to a wall charger or a car charger in order to recharge the power source. The network interfaces 26 may also interface with other devices via various communication networks and/or protocols. For example, the network interfaces 26 may be interfaces for a personal area network (PAN), such as a Bluetooth network, for a local area network (LAN), such as an 802.11x Wi-Fi network, and/or for a wide area network (WAN), such as a 3G or 4G cellular network. The power source 28 of the electronic device 10 may be any suitable source of power, such as a rechargeable lithium polymer (Li-poly) battery and/or an alternating current (AC) power converter.

The GPS device 30 may be enable the mobile device 10 to identify its current geographic location and well as its location in relation to another location. GPS information may be displayed on a map on the display 18 of the mobile device 10. The GPS information may be supplemented by other information, such as nearby wireless networks, to determine the current location of the mobile device 10. For example, in certain embodiments, the mobile device 10 may identify its current location by sensing and/or identifying nearby Wi-Fi networks. The mobile device 10 may be able to identify the geographic location of such Wi-Fi networks and thus, identify its own location based on which Wi-Fi networks it detects.

The motion-sensing device 32 may be configured to detect motion, speed, movement, and/or change in orientation of the mobile device 10. For example, the motion-sensing device 32 may include an accelerometer, a gyroscope, a magnetometer, and the like.

FIG. 2 depicts a front view of the mobile device 10, which represents one embodiment of the mobile device 10. It should be noted that while the depicted mobile device 10 is provided in the context of a cellular telephone, other types of mobile device (such as media players for playing music and/or video, personal data organizers, handheld game platforms, and/or combinations of such devices) may also be suitable be provided as the mobile device 10. By way of example, the mobile device 10 may be a model of an iPod® or iPhone® available from Apple Inc. of Cupertino, Calif. In other embodiments, the mobile device 10 may be a tablet-sized embodiment of the mobile device 10, which may be, for example, a model of an iPad® available from Apple Inc.

In the depicted embodiment, the mobile device 10 is in the form of a cellular telephone that may provide various additional functionalities (such as the ability to take pictures, record audio and/or video, listen to music, play games, and so forth). As discussed with respect to the generalized mobile device 10 of FIG. 1, the mobile device 10 may allow a user to connect to and communicate through the Internet or through other networks, such as local or wide area networks or cellular networks. The mobile device 10, may also communicate with other devices using short-range connections, such as Bluetooth and near field communication. The mobile device 10 may include an enclosure 36 to protect interior components from physical damage and to shield them from electromagnetic interference. The enclosure 36 may surround the display 18, which may display indicator icons 38. The indicator icons 38 may indicate, among other things, a cellular signal strength, Bluetooth connection, and/or battery life. The I/O interfaces 24 may open through the enclosure 36 and may include, for example, a proprietary I/O port from Apple Inc. to connect to external devices.

User input structures 40, 42, 44, and 46, in combination with the display 18, may allow a user to control the mobile device 10. For example, the input structure 40 may activate or deactivate the mobile device 10, the input structure 42 may navigate a user interface to a home screen, a user-configurable application screen, and/or activate a voice-recognition feature of the mobile device 10, the input structures 44 may provide volume control, and the input structure 46 may toggle between vibrate and ring modes. A microphone 48 may obtain a user's voice for various voice-related features, and a speaker 50 may enable audio playback and/or certain phone capabilities. A headphone input 52 may provide a connection to external speakers and/or headphones.

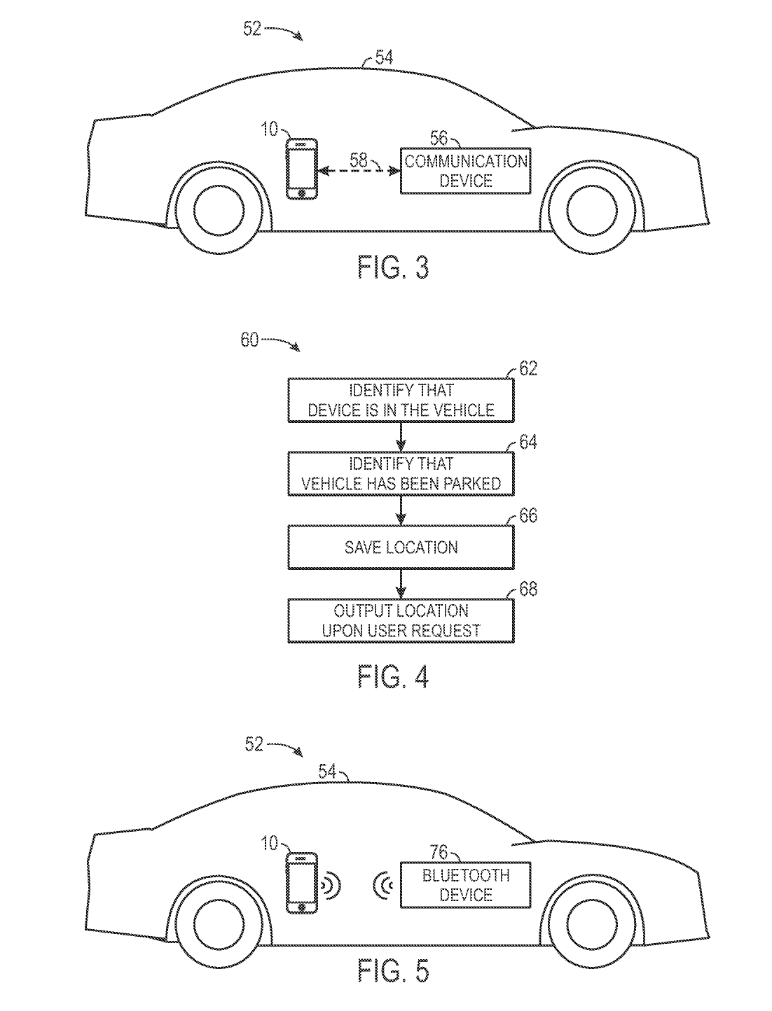

The mobile device 10 may be configured to save the location of a parked vehicle and later output that location. FIG. 3 illustrates a vehicle locator system 52 which includes the mobile device 10, a vehicle 54 having a communication system 56. The mobile device 10 and the communication system 56 of the vehicle 54 may be configured to communicate with each other via a wired or wireless communication channel 58 such as a Bluetooth network, USB cable, and the like. The communication system 56 may represent any suitable system used by the vehicle 54 that involves establishing communication with the mobile device 10. For example, the communication system 56 may be a hands-free calling system, a navigation system, an entertainment system, or an auxiliary input to a stereo system, and so forth. FIG. 4 illustrates a general process 60 of saving and outputting the location of the parked vehicle 54. Generally, the mobile device 10 first identifies (block 62) that the mobile device 10 is in the vehicle 54. This may indicate that a user (e.g., driver) has entered the vehicle 54. The mobile device 10 and the vehicle 54 may communicate with each other via a communication channel such as Bluetooth or a USB cable. The communication signal may indicate to the mobile device 10 that it is inside the vehicle 54. The system may then identify (block 64) that the vehicle 54 has been parked. This may include the mobile device 10 becoming communicatively decoupled from the vehicle 54 which may generally occur when the user exits the vehicle 54 and takes the mobile device 10 with them. In certain embodiments, in order to identify that the vehicle 54 has been parked, the system may identify that the vehicle 54 has first been moved (e.g., driven), even if the ultimate parking location did not change. In certain embodiments, movement of the vehicle 54 may be identified by utilizing the GPS device 30 of the mobile device 10, or the motion-sensing device 32 of the mobile device 10. Alternatively, movement of the vehicle 54 may be communicated to the mobile device 10 by the vehicle 54 itself via the communication channel 58. Specifically, detecting that the vehicle 54 has been parked may include detecting that the vehicle 54 has come to a stop by utilizing the GPS or accelerometer of the mobile device 10, or by receiving information from the car (e.g., the car is turned off). Additionally, the mobile device 10 may also be configured to detect when the mobile device 10 is no longer inside of, or within a certain distance from, the vehicle 54.

After detecting one or more indicators of the vehicle 54 being parked, the mobile device 10 may save (block 66) the GPS location of the mobile device 10 before or during the occurrence of one or more of these events. Because the mobile device 10 is generally still inside the vehicle 54 when the vehicle is being parked or close by, its GPS location is generally the GPS location of the location of the parked vehicle 54. The system may then output (block 68) the saved location upon receiving a request from the user. For example, when the user is trying to locate where they parked their vehicle 54, the user may prompt the mobile device 10 to output the saved parking location. The location may be outputted as a mark on a map, which may be displayed on the display 18 of the mobile device 10. The mobile device 10 may also provide the saved location in relation to the current location of the mobile device 10, in which the current location of the mobile device 10 may also be the current location of the user. As such, the user may be able to use the map to locate their vehicle 54.

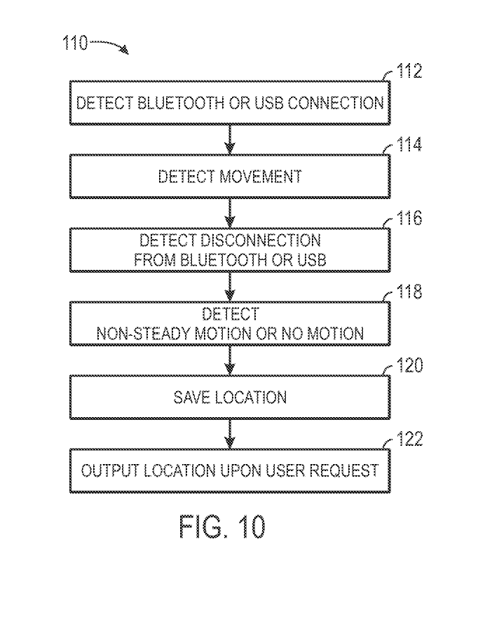

The systems and method of the present disclosure may include many embodiments. FIGS. 5-10 illustrate a subset of these embodiments for illustrative purposes. FIG. 5 illustrates an embodiment of the system in which the system includes a vehicle 54 and a mobile device 10, in which the vehicle 54 includes a Bluetooth device 76 capable of communicating over a Bluetooth network as well as with the vehicle 54. In certain embodiments, the Bluetooth device 76 may be a built-in Bluetooth device or an add-on Bluetooth accessory. The Bluetooth device 76 may allow the vehicle 54 to communicate wirelessly with external devices such as the mobile device 10 through the network interface 26, which may also have Bluetooth capabilities. The Bluetooth device 76 and the mobile device 10 may be configured to communicate with each other and send signals to each other if the Bluetooth device 76 and the mobile device 10 are within a certain distance from each other. As such, the mobile device 10 may be configured to detect whether or not it is inside or close to the vehicle 54 by sensing a Bluetooth signal from the Bluetooth device 76. Generally, if the mobile device 10 does sense a Bluetooth signal from the vehicle 54, it is able to identify that it is inside the vehicle 54. Likewise, if the mobile device 10 senses the Bluetooth signal is lost, the mobile device 10 may determine that it has exited the vehicle 54 or the vehicle 54 has been turned off As such conditions generally indicate that the vehicle 54 has been parked, the mobile device 10 may save its GPS location at that point as the location of the parked vehicle 54. Additionally, the mobile device 10 may be configured to save its location when the Bluetooth signal strength falls below a certain threshold.

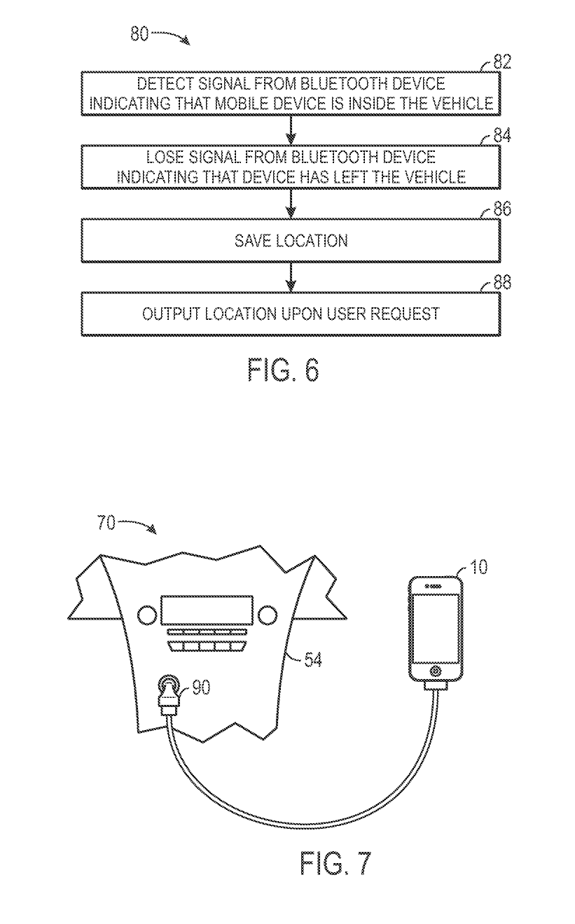

FIG. 6 illustrates a process 80 of saving and retrieving a vehicle 54 location using the Bluetooth device 76. The mobile device 10 may first detect (block 82) a signal from the Bluetooth device 76, indicating that the mobile device 10 is inside the vehicle 54 or within a certain distance of the vehicle 54. Generally, detection of a signal from the Bluetooth device 76 may also be an indication that the vehicle 54 is on. At this point, the vehicle 54 may have been started and may be being driven. The vehicle 54 may be driven to a certain location, where it may be parked. When the user exits the vehicle 54, assuming that the user carries the mobile device 10 with them, the mobile device 10 may lose (block 84) the signal from or be disconnected from the Bluetooth device 76. This may be a result of the mobile device 10 being moved a certain distance away from the vehicle 54 causing it to be out of the range of the Bluetooth device 76, or as a result of the vehicle 54 being turned off. Generally, this may be an indication that the vehicle 54 has been parked and the user has left the car. As such, the mobile device 10 may then save (block 86) its location during or just before it became disconnected from the Bluetooth device 76, which may also be the general location of the parked vehicle 54. The mobile device 10 may utilize its GPS function to identify and save the geographic location of the vehicle 54. Later, such as when the user wants to locate the vehicle 54, the user may prompt the mobile device 10 to identify the location where the vehicle 54 was parked, the mobile device 10 may output (block 88) the saved location of the vehicle 54 upon receiving such a user request. In certain embodiments, the output may be in the form of a map showing the location of the parked vehicle 54 and may also show the current location of the mobile device 10 itself, which may also be the current location of the user as well.

FIG. 7 illustrates an embodiment of the vehicle locator system 70 in which the mobile device 10 communicates with the vehicle 54 via a USB connection or a car charger 90. The USB connection or car charger 90 may also be configured to provide power from the vehicle 54 to the mobile device 10, charging the mobile device 10. Further, the mobile device 10 may be configured to identify when it is coupled to the car charger 90 rather than a conventional charger. For example, in certain embodiments, the car charger 90 may include a data line and/or connector with a different resistance value than that of a conventional charger. Thus, the mobile device 10 may differentiate the car charger 90 from a conventional charger. This allows the mobile device 10 to detect that it is in the vehicle 54 rather than just coupled to a conventional charger elsewhere. Being connected to the USB connection or car charger 90, which is also connected to the vehicle 54, may be an indication that the mobile device 10 is generally inside the vehicle 54. In certain embodiments, the mobile device 10 may be plugged into the USB connection or car charger 90 when the user enters the vehicle 54. Conversely, when the user parks the vehicle 54 and/or leaves the vehicle 54, the mobile device 10 may be unplugged from the car charger 90. This is may be an indication that the vehicle 54 has been parked. Thus, the mobile device 10 may automatically save its GPS location as the parking location when it detects that it has been disconnected from the USB connection or car charger 90. The mobile device 10 may later output the saved GPS location when prompted to do so by the user.

In certain embodiments, the car charger 90 may also include a built-in Bluetooth device such that the car charger may also communicate with the mobile device 10 via a Bluetooth network rather than the USB connection, as previously discussed. In such embodiments, the car charger 90 may essentially act as an add-on Bluetooth device configured to support communication between the vehicle 54 and the mobile device 10. In some embodiments, the Bluetooth signal provided by the car charger does not provide a communication link to any other vehicle 54 systems. Instead, in these embodiments, the car charger 90 merely provides the Bluetooth signal to indicate to the mobile device 10 that the mobile device 10 is in or near the vehicle 54.

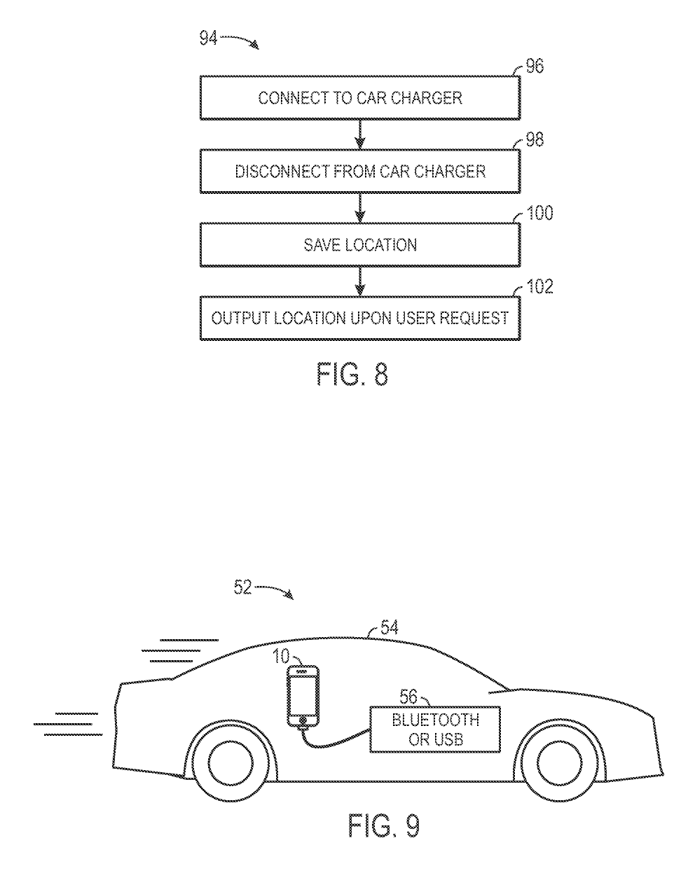

FIG. 8 is a process of saving and retrieving the location of the parked vehicle 54 using a USB connection or car charger 90. The mobile device 10 may first connect (block 96) to the USB connection or car charger 90, which is coupled to the vehicle 54. This indicates to the mobile device 10 that it is inside the car, and that the car is on and is currently, or about to be, driven. Later, such as when the user parks the vehicle 54, the mobile device 10 may disconnect (block 98) from the car charger 90. The mobile device 10, having detected the disconnection, may then save (block 100) its current GPS location as the location of the parked vehicle 54. Later, the mobile device 10 may then output (block 102) the saved location of the parked vehicle 54 upon receiving a request from the user.

FIG. 9 illustrates an embodiment of the vehicle locator system in which the mobile device 10 may be coupled to the vehicle 54 via a Bluetooth connection or a USB connection. In this embodiment, the mobile device 10 may further employ an accelerometer to detect when to save the GPS location as the location of the parked vehicle 54. Specifically, the mobile device 10 may employ its accelerometer or other motion-sensing device 32 to detect if and when the vehicle 54 is being driven and if and when the vehicle 54 comes to a stop to more accurately determine when the vehicle 54 is being parked.

If the mobile device 10 becomes disconnected from the USB connection or car charger before the vehicle 54 is actually parked, such as when the vehicle 54 is still being driven, the mobile device 10 may detect the movement and not save that location as the parked location. Generally, a signal generated by the accelerometer while the vehicle 54 is being driven may be indicative of relatively smooth and regular movement, as the vehicle 54 and thus accelerometer is travelling with generally smooth and/or slight acceleration and deceleration with minimal erratic movement. However, when the mobile device 10 is picked up by the user and taken out of the vehicle 54, the signal generated by the accelerometer may be indicative of relative erratic movement. As such, as the accelerometer signal is being processed by the mobile device 10, the mobile device 10 may be able to detect when it was removed from the vehicle 54 even if it was previously disconnected from the Bluetooth or USB connection. This may provide a more accurate indication of when the vehicle 54 is parked even if the mobile device is disconnected from the USB connection or car charger prematurely.

Additionally or alternatively, movement and speed of the vehicle 54 may also be detected by using the GPS device 30. For example, the GPS location of the mobile device 10 may be detected at a regular time intervals such that the speed of the vehicle 54 may be determined from the distance travelled with respect to time. Thus, the mobile device 10 may determine the speed of the vehicle 54 and its acceleration/deceleration via the GPS device 30. The mobile device 10 may also determine whether the vehicle 54 is most likely to be driven, parked, as well as whether the mobile device is being carried by a walking user. For example, if the speed detected by the mobile device is above 20 mph, the mobile device is most likely inside a moving vehicle 54 rather than with a walking user. As such, the mobile device 10 may save the current location as the parking location upon identifying one or more of the above conditions (indications of parking) and output the parking location when prompted.

FIG. 9 illustrates a process 110 of saving the location of a parked vehicle 54 using an accelerometer. In this embodiment, the mobile device 10 may be configured to detect (block 112) the Bluetooth or USB connection to the vehicle 54, indicating that the mobile device 10 is inside or within a certain distance of the vehicle 54. The mobile device 10 may then, through the accelerometer, detect (block 114) movement of the vehicle 54. The movement may generally refer to any acceleration or deceleration that normally occurs during driving. It should be noted that the mobile device 10 may generally be placed inside the vehicle 54 such that the mobile device 10 moves with the vehicle 54. Thus, acceleration or motion of the mobile device 10 sensed by the accelerometer may be indicative of acceleration or motion of the vehicle 54 as well. In order to detect that the vehicle 54 has been parked, the mobile device 10 first detects (block 116) that it is disconnected from the Bluetooth or USB connection. It may also detect (block 118) for accelerometer readings associated with parking of the car such as deceleration to a stop and/or erratic movement associated with being picked up by the user. After meeting one or more of these conditions, the mobile device 10 may save (block 120) its GPS location as the location of the parked car. Later, the mobile device 10 may then output (block 122) the saved location of the parked vehicle 54 upon receiving a request from the user.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A system comprising:
a electronic device comprising:
a networking interface or an I/O port, or both, configured to receive a communication signal from a communication system;
location-sensing logic; and
a processor configured to:
determine that the electronic device is inside of a vehicle by detecting the communication signal from the communication system associated with the vehicle via the networking interface or the I/O port, or both;
determine that the vehicle has been driven and subsequently parked; and
save the location of the electronic device based on the location-sensing logic upon determining that the vehicle has been parked.

2. The system of claim 1, wherein the electronic device comprises a global positioning system (GPS) device associated with the location-sensing logic.

3. The system of claim 1, wherein the electronic device is configured to:
output the saved location of the electronic device upon receiving a user request.

4. The system of claim 3, wherein the saved location of the electronic device is outputted via a map on a display.

5. The system of claim 1, wherein the networking interface comprises a Bluetooth interface configured to communicate with a Bluetooth device on the vehicle via a Bluetooth network, and the I/O port includes a USB interface configured to communicate with the vehicle via a USB cable or car charger.

6. The system of claim 1, wherein determining that the vehicle has been driven comprises detecting a change in location of the electronic device.

7. The system of claim 1, wherein determining that the vehicle has been parked comprises losing the communication signal from the vehicle or detecting when the communication signal strength is below a threshold.

8. A method comprising:
identifying that a mobile device is within a certain distance from a vehicle;
identifying in the mobile device that the vehicle is parked or being parked;
saving a GPS location of the mobile device when the vehicle is parked or being parked; and
outputting the GPS location with the mobile device upon a request.

9. The method of claim 8, wherein identifying that the mobile device is within a certain distance from the vehicle comprises detecting a signal from a Bluetooth device, wherein the Bluetooth device is coupled to the vehicle, and wherein identifying that the vehicle is parked comprises losing the signal from the Bluetooth device.

10. The method of claim 8, wherein identifying that the mobile device is within a certain distance from the vehicle comprises sensing that the mobile device is connected to a USB connector or car charger, wherein the USB connector or car charger is coupled to the vehicle, and wherein identifying that the vehicle is parked comprises subsequently detecting that the mobile device is disconnected from the USB connector or car charger.

11. The method of claim 8, comprising:
detecting acceleration or movement of the vehicle via a motion-sensing device coupled to the mobile device;

12. The method of claim 11, wherein identifying that the vehicle is parked comprises detecting that the vehicle is not travelling.

13. A system, comprising:
a mobile device configured to be communicatively coupled to a vehicle via a communication device associated with the vehicle, automatically save a first GPS location of the mobile device upon a predetermined condition, and output the first GPS location of the mobile device upon receiving a request, wherein the predetermined condition comprises receiving an indication of proximity to the vehicle and then receiving an indication of the vehicle being parked.

14. The system of claim 13, wherein the first GPS location of the mobile device comprises a parking location of the vehicle.

15. The system of claim 13, wherein the communication device comprises a USB connection or charging device configured to communicatively couple the vehicle and the mobile device and indicate to the mobile device its association with the vehicle.

16. The system of claim 13, wherein the communication device comprises a Bluetooth device configured to communicate with the mobile device over a Bluetooth network when the mobile device is within a certain distance from the Bluetooth device.

17. The system of claim 15, wherein the indication of proximity comprises a signal indicating being coupled to the vehicle via the USB connection or charging device, and the indication of the vehicle being parked comprises losing the signal indicating being coupled to the vehicle via the USB connection or charging device.

18. The system of claim 16, wherein the indication of proximity comprises a Bluetooth signal from the Bluetooth device and the indication of the vehicle being parked comprises losing Bluetooth signal from the Bluetooth device.

19. The system of claim 13, wherein the mobile device is configured to output the first GPS location of the mobile device by displaying the first GPS location of the mobile device on a map.

20. The system of claim 13, wherein the mobile device comprises an accelerometer configured to detect that the vehicle is being driven, when it is stopped, and when it is picked up by a user.

21. The system of claim 20, wherein the indication of the vehicle being parked comprises at least one of the mobile device being communicatively decoupled from the vehicle, an accelerometer detection of the vehicle being stopped, an accelerometer detection of the mobile device being picked up by the user, or a combination thereof

22. The system of claim 16, wherein the Bluetooth device comprises at least one of a built-in Bluetooth device or an add-on Bluetooth device.

23. A tangible, non-transitory, computer-readable medium comprising instructions configured to be executed by a mobile device, the instructions configured to:
determine if the mobile device is within a certain distance from a vehicle;
determine if the vehicle is parked or being parked;
save a location of the mobile device when the vehicle is parked; and
output the saved location of the mobile device upon a request.

24. The tangible, non-transitory, computer-readable medium of claim 23, wherein the instructions are configured to determine if the mobile device detects a Bluetooth signal from the vehicle, determine if the mobile is coupled to a USB connection to the vehicle, or both, to determine if the mobile device is within a certain distance from the vehicle.

25. A mobile device comprising:
a network interface configured to communicate with a device on a network in a vehicle;
a global positioning system (GPS) device; and
a processor configured to:
determine that the mobile device is inside the vehicle by detecting a signal from the device in the vehicle;
determine that the vehicle has been parked by detecting a lack of the signal from the device in the vehicle or by detecting a signal strength that is lower than a threshold;
save the GPS location of the mobile device determined by the GPS device when the mobile device determined that the vehicle has been parked.
output the saved GPS location upon a request.

26. The mobile device of claim 25, wherein the network comprises a Bluetooth network.
